(19) United States
(12) Patent Application Publication
(10) Pub. No.: US 2021/0062871 A1
(43) Pub. Date: Mar. 4, 2021

(54) MULTIPLE CLUTCH WITH ENCODER PART FOR ROTATIONAL SPEED DETECTION; AND CLUTCH ARRANGEMENT WITH MULTIPLE CLUTCH AND DUAL-MASS FLYWHEEL

(71) Applicant: Schaeffler Technologies AG & Co. KG, Herzogenaurach (DE)

(72) Inventors: Florian Krebs, Bühl (DE); Tobias Bär, Achern (DE); Jasper Fink, Sasbach (DE); Franck Billmann, Hunspach (FR); Oliver Nöhl, Bühl (DE); Robert Jakowski, Bühlertal (DE); Tobias Bauer, Achern (DE)

(73) Assignee: Schaeffler Technologies AG & Co. KG, Herzogenaurach (DE)

(21) Appl. No.: 16/962,247

(22) PCT Filed: Dec. 17, 2018
(86) PCT No.: PCT/DE2018/101025

§ 371 Date: Jul. 15, 2020

(30) Foreign Application Priority Data
Jan. 23, 2018 (DE) 10 2018 101 460.0
Apr. 10, 2018 (DE) 10 2018 108 396.3

(51) Int. Cl. F16D 21/06; F16D 13/70

(52) U.S. Cl. CPC F16D 21/06; F16D 13/70; F16D 2300/18; F16D 2021/0692; F16D 2021/0615

(57) ABSTRACT

A multiple clutch for a drivetrain of a motor vehicle includes an a axis of rotation, a first clutch, a second clutch, and an encoder part. The first clutch has a first clutch first component and a first clutch second component selectively rotationally connectable to the first clutch first component. The second clutch has a second clutch first component and a second clutch second component selectively rotationally connectable to the second clutch first component. The encoder part has a rotational speed or rotational position detection geometry, is arranged to be operatively connected to a sensor, and is used as a connecting element which rotationally conjointly connects the first clutch first component to the second clutch first component.

### CROSS-REFERENCE TO RELATED APPLICATIONS

This application is the United States National Phase of PCT Appln. No. PCT/DE2018/101025 filed Dec. 17, 2018, which claims priority to German Application Nos. DE102018101460.0 filed Jan. 23, 2018 and DE102018108396.3 filed Apr. 10, 2018, the entire disclosures of which are incorporated by reference herein.

### TECHNICAL FIELD

The disclosure relates to a multiple clutch for a drivetrain of a motor vehicle, such as a car, truck, bus or other commercial vehicle, having a first clutch and a second clutch. Each (both the first and the second) clutch has a first clutch component, and selectively has a second clutch component that can be rotationally connected to the first clutch component, and an encoder part that is operatively connected to a sensor and has a rotational speed and/or rotational position detection geometry. The disclosure also relates to a clutch arrangement with this multiple clutch and a dual-mass flywheel.

### BACKGROUND

Prior art is known, for example, from DE 10 2017 102 733 A1. A torque transmission device with a driving ring is disclosed therein. The driver ring is thus part of the flywheel.

In the designs known from the prior art, it has been found to be a disadvantage that the multiple clutches implemented are either relatively complex and of large construction, or that the encoder part, when the encoder part is arranged on the side of a dual-mass flywheel outside the multiple clutch, contributes to the generation of unreliable measurement data.

### SUMMARY

According to the disclosure, an encoder part is used as a connecting element which (directly) rotationally conjointly connects the first clutch component of the first clutch to the first clutch component of the second clutch.

As a result, an element which is provided in any case is formed directly as an encoder part and the structure of the multiple clutch is simplified. This results in an even more compact design of the multiple clutch in the axial direction. In addition, by integrating the encoder part into the multiple clutch, the rotational state of the first clutch component of the first and second clutch can be reliably detected.

If the encoder part is designed in the form of a ring/annular disc, the encoder part is compact.

The encoder part may extend, e.g., directly in the radial direction, between two connecting regions of the first clutch components of the two (first and second) clutches which overlap/overlay in an axial direction with respect to an axis of rotation of the multiple clutch. In other words, the encoder part may extend between a first connecting region provided by the first clutch component of the first clutch and a second connecting region provided by the first clutch component of the second clutch, and the first connecting region and the second connecting region may extend directly in the axial direction to overlap/overlay each other. This further reduces the installation space requirement.

The first clutch component of the first clutch and/or the first clutch component of the second clutch may have at least one friction element, e.g., a plurality of friction elements, in a rotationally fixed (first) carrier and the (first) carriers of the two clutches may be directly rotationally connected to each other via the encoder part.

The encoder part may have an annular region that forms the rotational speed and/or rotational position detection geometry and the annular region may be arranged radially outside the first clutch component of the first clutch and/or the first clutch component of the second clutch with respect to an axis of rotation of the multiple clutch. This results in a compact radial arrangement.

The rotational speed and/or rotational position detection geometry may have a plurality of holes arranged next to one another at regular intervals along a circumferential direction. The holes may be designed as through-holes. The holes may also be implemented in a closed annular region, i.e. delimited in the axial direction by webs of the annular region. This results in a closed form of the rotational speed and/or rotational position detection geometry.

Alternatively or additionally, the rotational speed and/or rotational position detection geometry may have a plurality of teeth/claws arranged next to one another at regular intervals along a circumferential direction. This further simplifies the manufacturing effort for the encoder part.

The teeth project outwards in an axial direction or a radial direction with respect to the axis of rotation. This results in an open form of the rotational speed and/or rotational position detection geometry, which takes up a small amount of space.

The encoder part may have at least one first axial through-hole into which the first clutch component (with the first carrier thereof, for example) of the first clutch is received in a rotationally fixed manner, forming a positive-fit connection.

Furthermore, the encoder part may have at least one second axial through-hole, into which the first clutch component (with the first carrier thereof, for example) of the second clutch is received in a rotationally fixed manner, with a positive-fit connection. This reduces the assembly effort.

A (first) return spring acting on a (first) pressure element of the first clutch may be clamped axially between the first pressure element and the encoder part. In this regard, a (second) return spring acting on a (second) pressure element of the second clutch may be clamped axially between the second pressure element and the encoder part.

With regard to the first and second through-holes of the encoder part, the first through-holes may be arranged radially offset from the second through-holes. The first through-holes may be arranged radially outside the second through-holes.

The clutches may be realized as friction disc clutches. In addition, friction elements of the first clutch may be arranged radially outside of friction elements of the second clutch. This results in a radial nesting of the clutches and thus a further reduction in the axial space required.

The first clutch and the second clutch may be implemented as a double clutch device and may be designed to run wet. The multiple clutch is may be implemented as a whole as a double clutch device or as a triple clutch device.

Furthermore, the disclosure relates to a clutch arrangement with the multiple clutch according to at least one of the embodiments described above and a dual-mass flywheel. A primary part of the dual-mass flywheel is prepared for the rotationally fixed connection to an output shaft of an internal combustion engine and a secondary part connected to the primary part in a manner so as to damp torsional vibrations is connected to the first clutch component of the first clutch and/or non-rotationally connected to the first clutch component of the second clutch.

In other words, according to the disclosure a sensor ring/an encoder contour (encoder part) for rotational speed measurement is realized in a (e.g., wet) double clutch (multiple clutch). The sensor ring is integrated in the double clutch structure to filter irregularities of the engine (internal combustion engine) through the upstream dual-mass flywheel, so that the rotational speed signal is not negatively influenced.

### BRIEF DESCRIPTION OF THE DRAWINGS

The disclosure will now be explained in more detail with reference to figures, in which context various exemplary embodiments are also shown. In the figures:

FIG. 1 shows a schematic longitudinal sectional view of a multiple clutch according to a first exemplary embodiment, wherein the structure of the entire multiple clutch is clearly visible,

FIG. 2 shows a perspective view of an encoder part used in FIG. 1 for the direct connection of a first clutch component of a first clutch with a first clutch component of a second clutch, wherein a rotational speed and/or rotational position detection geometry can be seen introduced on a radial outside of the encoder part which is implemented by a plurality of holes distributed in a circumferential direction,

FIG. 3 shows a detailed longitudinal sectional view of a multiple clutch according to a second exemplary embodiment, wherein the multiple clutch can be seen in the region of the rotational speed and/or rotational position detection geometry of the encoder part, which is operatively connected to a sensor during operation,

FIG. 4 shows a perspective view from one side of the encoder part used in FIG. 3, to which a plurality of teeth arranged uniformly distributed in the circumferential direction can be seen and project in the axial direction to form the rotational speed and/or rotational position detection geometry, and

FIG. 5 shows two detailed views of an encoder part as it is used in a multiple clutch according to a third exemplary embodiment, wherein a left-hand partial view of FIG. 5 shows a longitudinal sectional view of the encoder part in the region of the rotational speed and/or rotational position detection geometry thereof, so that a radially outwardly projecting tooth shaped as a bead of the rotational speed and/or rotational position detection geometry can be seen in section, and wherein a right-hand partial view of FIG. 5 shows an end view of a plurality of these teeth.

The figures are only schematic in nature and serve only for understanding the disclosure. The same elements are provided with the same reference symbols. The different features of the various exemplary embodiments can also be freely combined with one another.

### DETAILED DESCRIPTION

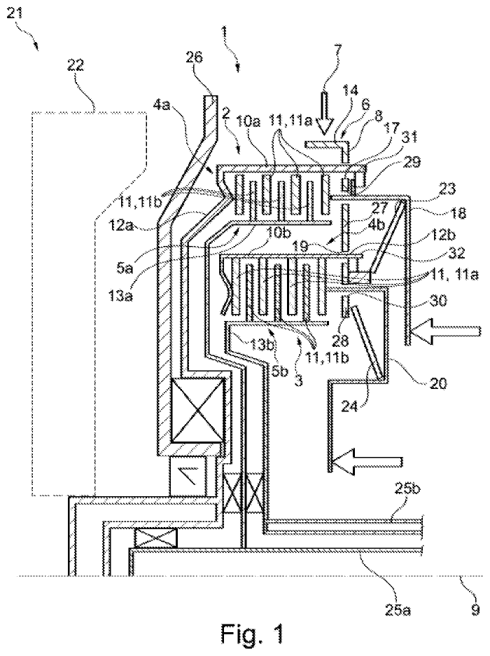

In FIG. 1, the basic structure of a multiple clutch 1 according to the disclosure can initially be seen particularly well. The multiple clutch 1 is realized in this exemplary embodiment as a double clutch; according to other embodiments, it is also designed as a triple clutch. The multiple clutch 1 has a first clutch 2 and a second clutch 3. The two clutches 2 and 3, seen along a torque transmission path implemented during operation, are inserted between an output shaft of an internal combustion engine (not shown here for the sake of clarity) and a transmission input shaft 25a, 25b of a transmission (not shown in more detail for the sake of clarity). The multiple clutch 1 is therefore part of a drivetrain of a motor vehicle during operation. The multiple clutch 1, as illustrated by broken lines in FIG. 1, is operatively connected to a dual-mass flywheel 22 in a preferred embodiment. The arrangement of the multiple clutch 1 and the dual-mass flywheel 22, referred to as a clutch arrangement 21, is then used again in the entirety thereof during operation between the output shaft of the internal combustion engine and the transmission input shafts 25a, 25b of the transmission.

An axis of rotation of the multiple clutch 1, about which the multiple clutch 1 rotates/can be rotated at least partially during operation, is provided with the reference symbol 9. The directional information used relates to this axis of rotation 9. Consequently, an axial direction is a direction along the axis of rotation 9, a radial direction is a direction perpendicular to the axis of rotation 9 and a circumferential direction is a tangential direction along an imaginary circular line of constant diameter that runs concentrically around the axis of rotation 9.

In this embodiment, the first clutch 2 is realized as a friction clutch, namely as a friction disc clutch. According to further embodiments, the first clutch 2 is also realized as single-disc clutch or as another multiple-disc clutch. The structure of the second clutch 3 largely corresponds to that of the first clutch 2. The second clutch 3 is consequently also designed as a friction disc clutch. Regardless of the design of the first clutch 2, however, the second clutch 3 is designed in a further embodiment as a single-disc clutch or as another multi-disc clutch. The first clutch 2 serves as a coupling element between the output shaft/the dual-mass flywheel 22 and a first transmission input shaft 25a. The second clutch 3 serves as a coupling element between the output shaft/the dual-mass flywheel 22 and a second transmission input shaft 25b. The transmission input shafts 25a and 25b are typically arranged radially nested one inside the other. In this embodiment, the second transmission input shaft 25b is arranged radially outside the first transmission input shaft 25a.

The first clutch 2 has a first clutch component 4a. The first clutch component 4a also has a (first) carrier 12a, which functions as an outer disc carrier. A plurality of friction elements 11 in the form of a plurality of first friction elements 11a are received on a sleeve-shaped (first) connecting region 10a of the first carrier 12a in a rotationally fixed manner and axially displaceable relative to one another. The first connecting region 10a runs in the axial direction. The first friction elements 11a of the first clutch component 4a project inwards from the first connecting region 10a in the radial direction.

The first friction elements 11a of the first clutch 2 interact with a plurality of friction elements 11 in the form of a plurality of second friction elements 11b of a second clutch component 5a of the first clutch 2. The friction elements 11a, 11b of the first clutch component 4a and the second clutch component 5a overlap in the radial direction and alternate with one another in the axial direction. The second clutch component 5a also has a (second) carrier 13a which extends inwards in the radial direction. The second carrier 13a is designed as an inner disc carrier. The second carrier 13a receives the second friction elements 11b in a rotationally fixed manner and axially displaceable relative to one another. The second friction elements 11b project outwards from the second carrier 13a in the radial direction. The second carrier 13a and consequently the second clutch component 5a are connected to the first transmission input shaft 25a in a rotationally fixed manner.

Since the structure of the second clutch 3 largely corresponds to that of the first clutch 2, the second clutch 3 also has a first clutch component 4b, which is equipped with a first carrier 12b designed as an outer disc carrier with a plurality of friction elements 11 in the form of a plurality of first friction elements 11a. The first friction elements 11a are received on the first carrier 12b in a rotationally fixed manner and displaceable in the axial direction relative to one another. In particular, the first friction elements 11a are accommodated on a sleeve-shaped (second) connecting region 10b of the first carrier 12b in a rotationally fixed manner and axially displaceable relative to one another. The first friction elements 11a of the first clutch component 4b project inwards from the second connecting region 10b in the radial direction. The second connecting region 10b runs in the axial direction.

The first friction elements 11a of the first clutch component 4b interact with a plurality of friction elements 11 in the form of a plurality of second friction elements 11b of a second clutch component 5b of the second clutch 3. The second friction elements 11b of the two clutch components 4b and 5b are arranged alternately in the axial direction. The second friction elements 11b of the second clutch component 5b are displaceable in the axial direction relative to one another and are non-rotationally received on a second carrier 13b of the second clutch component 5b. The second carrier 13b and consequently the second clutch component 5b are connected in a rotationally fixed manner to the second transmission input shaft 25b.

In relation to the general structure of the multiple clutch 1, FIG. 1 also shows that the two clutches 2 and 3 are arranged nested in the radial direction. Accordingly, the friction elements 11; 11a, 11b of the first clutch 2 are arranged radially outside the friction elements 11; 11a, 11b of the second clutch 3. The friction elements 11; 11a, 11b of the first clutch 2 are (for the most part) arranged in the axial direction at the same height as the friction elements 11; 11a, 11b of the second clutch 3. The two connecting regions 10a, 10b of the first clutch 2 and the second clutch 3 therefore overlay/overlap/overhang in the axial direction.

In an engaged position of the respective clutch 2, 3, the friction elements 11; 11a, 11b of the respective clutch 2, 3 are connected to one another in a rotationally fixed manner and are freely rotational relative to one another in a disengaged position. To adjust the respective clutch 2, 3, i.e. to move the friction elements 11; 11a, 11b between the engaged and disengaged positions, a pressure element 18, 20 for each clutch 2, 3 with a corresponding actuating unit (not shown here for the sake of clarity) is operatively connected to the respective friction elements 11; 11a, 11b. A first pressure element 18 acts on the axial displacement position of the friction elements 11; 11a, 11b of the first clutch 2; a second pressure element 20 acts on the axial displacement position of the friction elements 11; 11a, 11b of the second clutch 3. In this embodiment, the pressure elements 18, 20 are each designed as pressure pots. To support the pressure elements 18, 20 in an initial position (disengaged position), a return spring 23, 24 acts in a resetting manner on the respective pressure element 18, 20.

According to the disclosure, an encoder part 8 is now used, which at the same time serves to detect a rotational speed of the first clutch components 4a, 4b. In this context, the encoder part 8 is a connecting element which directly rotationally conjointly connects the first clutch components 4a, 4b. The encoder part 8 connects the two connecting regions 10a, 10b directly to one another. The encoder part 8 extends between the connecting regions 10a, 10b, which overlap in the axial direction, directly in the radial direction.

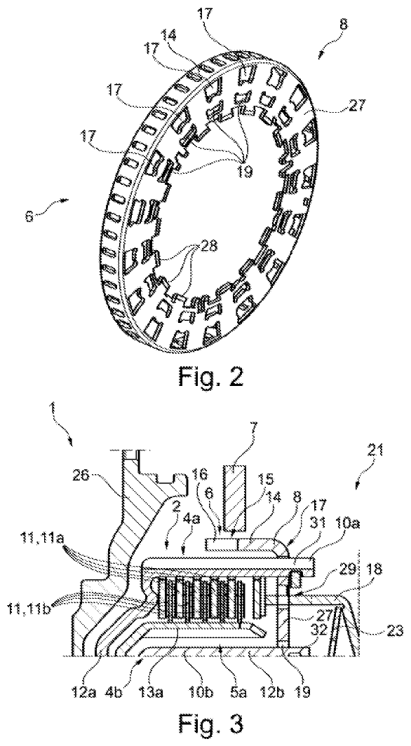

The encoder part 8 of the first embodiment is illustrated alone in FIG. 2. The encoder part 8 as a whole is designed as an annular disc. The encoder part 8 has an annular region 14 arranged radially on the outside. This annular region 14 directly has a rotational speed and/or rotational position detection geometry 6, which can be detected by a sensor 7. For the sake of simplicity, in FIG. 1 the sensor 7 is only shown as an arrow which illustrates the measuring direction. During operation, the sensor 7 may be accommodated in a housing 26 of the multiple clutch 1. In further embodiments, however, the sensor 7 can also be designed as a component outside the multiple clutch 1. The encoder part 8 thus has the function of a part to be detected by the sensor 7. Due to the design thereof, the encoder part 8 is also referred to as an encoder ring/sensor ring.

The rotational speed and/or rotational position detection geometry 6 has a plurality of holes 15 (ref. FIG. 3) made in the annular region 14 and arranged to be uniformly distributed in the circumferential direction. The holes 15 are spaced apart at regular intervals. The holes 15 are introduced into the annular region 14 as through-holes running in the radial direction. The holes 15 are delimited/closed on both axially facing sides. The holes 15 are largely the same size, i.e. in particular having the same radial dimension. This implements a geometry for rotational speed detection. One or more holes 15 may also differ in the size thereof (dimensioned in the circumferential direction, for example) from the size of the other holes 15. A single hole 15 made from the totality of holes 15 may be larger than the other holes 15, so that a geometry for rotational position detection of the first clutch components 4a and 4b is enabled during operation. For the sake of clarity, a further larger hole 15 is not shown in the figures.

The annular region 14 is adjoined by a disc region 27 which extends inwards in the radial direction from the annular region 14. The disc region 27 is the region that connects the two first carriers 12a, 12b to one another and extends radially between these carriers 12a, 12b/the connecting regions 10a, 10b. The disc region 27 is connected to the first carrier 12a of the first clutch 2 in a positive-fit manner in the circumferential direction. The disc region 27 has a plurality of first through-holes 17 arranged to be distributed in the circumferential direction. A plurality of (first) lugs 31 of the first connecting region 10a/first carrier 12a, projecting in the axial direction and distributed in the circumferential direction, project into the first through-holes 17 in a positive-fit manner and are supported in these first through-holes 17 in the rotational/circumferential direction. In addition, the first connecting region 10a/first carrier 12a is firmly supported in the axial direction relative to the encoder part 8.

The disc region 27 is also connected to the first carrier 12b of the second clutch 3 in a positive-fit manner in the circumferential direction. Radially within the first through-holes 17 arranged along an imaginary circular line are arranged a plurality of second through-holes 19 distributed in the circumferential direction. The second through-holes 19 are also lined up along an imaginary circular line. A plurality of (second) lugs 32 of the second connecting region 10b/first carrier 12b projecting in the axial direction and distributed in the circumferential direction project into the second through-holes 19 and are supported in a positive-fit manner in these second through-holes 19 in the rotational/circumferential direction. In addition, the second connecting region 10b/first carrier 12b is firmly supported in the axial direction relative to the encoder part 8.

As also indicated in FIG. 1 and not further developed in FIG. 2 for the sake of clarity, further (third) through-holes 29 are formed in the disc region 27. Projections of the first pressure element 18 projecting in the axial direction project through the third through-holes 29, so that the first pressure element 18 and an end friction element 11 of the first clutch 2 are in operative connection. As also indicated in FIG. 1 and not further developed in FIG. 2 for the sake of clarity, further (fourth) through-holes 30 are formed in the disc region 27. Projections of the second pressure element 20 projecting in the axial direction project through the fourth through-holes 30 to cooperate with an end friction element 11 of the second clutch 3.

On a radial inside of the encoder part 8, a plurality of force introduction lugs 28, which are arranged distributed along the circumference, project in the radial direction inwards. These force introduction lugs 28 form an annular contact region for the second return spring 24 on the side of the encoder part 8. The second return spring 24 is thereby axially clamped between the encoder part 8 and the second pressure element 20. The first return spring 23 is also axially clamped between the encoder part 8 and the first pressure element 18.

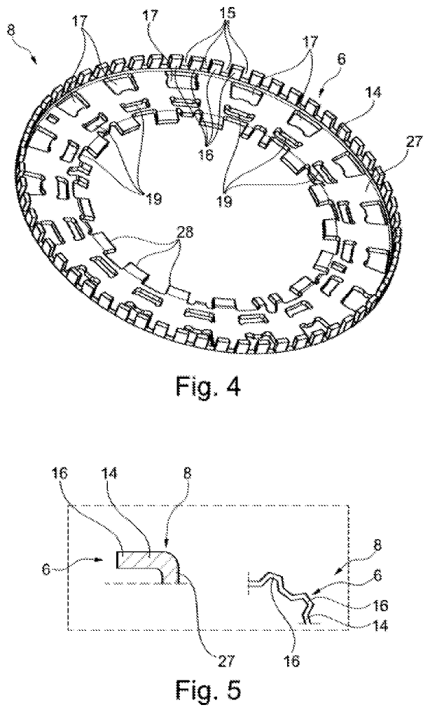

In connection with FIGS. 3 and 4, a second exemplary embodiment is illustrated, and in connection with FIG. 5 a third exemplary embodiment is illustrated. The structure and function of these further exemplary embodiments largely correspond to the first exemplary embodiment of FIGS. 1 and 2, and for the sake of brevity only the essential differences from this first exemplary embodiment are described below.

In the second exemplary embodiment of FIGS. 3 and 4, the rotational speed and/or rotational position detection geometry 6 is configured differently than in the first exemplary embodiment. Here, the annular region 14 now has teeth open in the axial direction. The annular region 14 has a plurality of equally dimensioned teeth 16 which are arranged at uniform intervals in the circumferential direction and project in the axial direction. Holes 15 according to the first exemplary embodiment, which are open in the axial direction, are thus again realized.

The third exemplary embodiment is illustrated in connection with FIG. 5. In comparison to the second exemplary embodiment, the toothing is now realized by a bead structure. The annular region 14 therefore has a plurality of teeth 16 projecting outwards in the radial direction. The teeth 16 are arranged at uniform intervals in the circumferential direction and have the same dimensions. The holes 15, which are now formed as blind holes/depressions, thus again form between the teeth 16.

In other words, according to the disclosure, by integrating the function of a sensor contour (encoder part 8) on the double clutch 1, the engine irregularities are already filtered by the upstream dual-mass flywheel 22 and do not negatively influence the rotational speed signal. The sensor contour 8 is integrated into existing components of the double clutch 1 (designed as a connecting element). The encoder contour 8 is integrated on the connecting web (encoder part 8 as a connecting element), which connects the two outer disc carriers (first carrier 12a, 12b of the first clutch 2 and the second clutch 3). This can be done on the basis of different variants, for example through-holes 15, teeth 16, claws, etc. The disclosure can also be applied to other types of clutches and/or double clutches.

### REFERENCE NUMERALS

1 Multiple clutch

2 First clutch

3 Second clutch

4a First clutch component of the first clutch

4b First clutch component of the second clutch

5a Second clutch component of the first clutch

5b Second clutch component of the second clutch

6 Rotational speed and/or rotational position detection geometry

7 Sensor

8 Encoder part

9 Axis of rotation

10a Connecting region of the first clutch

10b Connecting region of the second clutch

11 Friction element

12a First carrier of the first clutch

12b First carrier of the second clutch

13a Second carrier of the first clutch

13b Second carrier of the second clutch

14 Annular region

15 Hole

16 Tooth

17 First through-hole

18 First pressure element

19 Second through-hole

20 Second pressure element

21 Clutch arrangement

22 Dual-mass flywheel

23 First return spring

24 Second return spring

25a First transmission input shaft

25b Second transmission input shaft

26 Housing

27 Disc region

28 Force introduction lug

29 Third through-hole

30 Fourth through-hole

31 First lug

32 Second lug

1.-10. (canceled)

11. A multiple clutch for a drivetrain of a motor vehicle, comprising:
an axis of rotation;
a first clutch comprising:
a first clutch first component; and
a first clutch second component selectively rotationally connectable to the first clutch first component;
a second clutch comprising:
a second clutch first component; and
a second clutch second component selectively rotationally connectable to the second clutch first component; and
an encoder part:
comprising a rotational speed or rotational position detection geometry;
arranged to be operatively connected to a sensor; and
used as a connecting element which rotationally conjointly connects the first clutch first component to the second clutch first component.

12. The multiple clutch of claim 11, wherein:
the first clutch first component comprises a first connecting region;
the second clutch first component comprises a second connecting region, overlapping the first connecting region in an axial direction with respect the axis of rotation; and
the encoder part extends between the first connecting region and the second connecting region.

13. The multiple clutch of claim 11, wherein:
the first clutch first component comprises a first carrier for rotationally receiving a first friction element;
the second clutch first component comprises a second carrier for rotationally receiving a second friction element; and
the first carrier and the second carrier are rotationally connected to each other directly via the encoder part.

14. The multiple clutch of claim 11, wherein:
the encoder part comprises an annular region which forms the rotational speed or rotational position detection geometry; and
the annular region is arranged radially outside of the first clutch first component or the second clutch first component with respect to the axis of rotation.

15. The multiple clutch of claim 11, wherein the rotational speed or rotational position detection geometry comprises a plurality of holes arranged next to one another at regular intervals along a circumferential direction.

16. The multiple clutch of claim 11, wherein the rotational speed or rotational position detection geometry comprises a plurality of teeth arranged next to one another at regular intervals along a circumferential direction.

17. The multiple clutch of claim 16, wherein the plurality of teeth project outwards in an axial direction or a radial direction with respect to the axis of rotation.

18. The multiple clutch of claim 11, wherein:
the encoder part comprises a first axial through-hole; and
the first clutch first component is rotationally received in the first axial through-hole to form a positive-fit connection.

19. The multiple clutch of claim 11, wherein:
the encoder part comprises a second axial through-hole; and
the second clutch first component is rotationally received in the second axial through-hole to form a positive-fit connection.

20. A clutch arrangement comprising:
the multiple clutch of claim 11; and
a dual-mass flywheel comprising:
a primary part prepared for a rotationally fixed connection to an output shaft of an internal combustion engine; and
a secondary part:
connected to the primary part in a manner so as to damp torsional vibrations; and
connected to the first clutch first component or non-rotationally connected to the second clutch first component.
